(19) United States
(12) Patent Application Publication
(10) Pub. No.: US 2025/0094816 A1
(43) Pub. Date: Mar. 20, 2025

(54) LLM FINE-TUNING FOR TEXT GENERATION

(71) Applicant: ORACLE INTERNATIONAL CORPORATION, Redwood Shores, CA (US)

(72) Inventors: Yazhe HU, Bellevue, WA (US); Mengqing GUO, Issaquah, WA (US); Zheng WANG, Sammamish, WA (US); Tao SHENG, Bellevue, WA (US); Jun QIAN, Newcastle, WA (US); Vinod MAMTANI, Bellevue, WA (US)

(21) Appl. No.: 18/650,904

(22) Filed: Apr. 30, 2024

Related U.S. Application Data
(60) Provisional application No. 63/538,663, filed on Sep. 15, 2023.

(51) Int. Cl. G06N 3/091

(52) U.S. Cl. CPC G06N 3/091

(57) ABSTRACT

Systems, methods, and other embodiments associated with automated fine-tuning of text generation for large language models are described herein. In one embodiment, a method accesses a collection of text samples. The text samples include a natural language text prompt that combines content and instructions. The method extracts the instructions from the text prompt. The method fine-tunes a large language model to generate text in natural language based on a text generation loss function that penalizes non-compliance with the extracted instructions by a generated text response to the text prompt. The method generates an evaluation score for performance of the tuned large language model as a text generator based on a value of the text generation loss function for a second generated text response. And, the method automatically signals that the fine tuning of the tuned large language model is complete in response to the evaluation score satisfying a threshold.

### CROSS REFERENCE TO RELATED APPLICATIONS

This disclosure claims the benefit of U.S. Provisional Patent Application Ser. No. “63/538,663” filed Sep. 15, 2023, titled “Large Language Model Fine Tuning”, having inventors: Yazhe HU, Zheng WANG, Mengqing GUO, Tao SHENG, Jun QIAN, and Vinod MAMTANI, and assigned to the present assignee, the entirety of which application is incorporated by reference herein in its entirety.

### BACKGROUND

A large language model (LLM) is an artificial intelligence system that has been trained on vast amounts of text data to generate appropriate human language text responses to human language prompts. A LLM is capable of performing many diverse tasks, such as text generation. It is not currently possible to automatically evaluate and improve the performance of the LLM for text generation.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a text generation tuning system associated with automated LLM fine-tuning for text generation.

FIG. 2 illustrates an example text generation tuning pipeline for automated fine-tuning of an LLM-based text generator.

FIG. 3 illustrates one embodiment of a text generation tuning method associated with automated LLM fine-tuning for text generation.

FIG. 4 illustrates an embodiment of a computing system configured with the example systems and/or methods disclosed.

### DETAILED DESCRIPTION

Systems, methods, and other embodiments are described herein that provide automated fine-tuning of text generation by large language models (LLMs). In one embodiment, a text generation tuning system automatically fine-tunes an LLM to improve performance of natural language text generation by the LLM. For example, the text generation tuning system automatically adjusts the LLM to cause the LLM to generate outputs that are more closely aligned with expectations for generating a body of natural language text in response to natural language requirements or instructions to the LLM. And, for example, the text generation tuning system automatically evaluates improvement of LLM text generation performance to control deployment of the improved LLM to a production environment. In one embodiment, the LLM text generation tuning system quantifies improvement to the performance of the LLM at the task of text generation, rendering the improvement verifiable.

In one embodiment, the text generation tuning system is an improvement to LLM fine-tuning because it can automatically retrain the text generation ability of an LLM based on LLM prompts alone, without reference to model responses to the LLM prompts during the retraining. In particular, text generation ability of an LLM may be enhanced by causing the LLM to follow natural language requirements or instructions in a prompt, and retraining the LLM based on a loss function that evaluates compliance with the prompt itself, rather than with a model response. The use of the model responses is instead reserved for evaluation of LLM improvement, a process in which a model response to a prompt is compared to the LLM-generated response to the prompt. The overhead for model responses used in LLM fine-tuning for text generation is thereby substantially reduced.

For example, the data set for training is reduced by eliminating model responses to prompts, rather than including a model response for every prompt, substantially improving—i.e., shrinking—the size of storage used by the data set. Further, the testing data set that includes model responses to prompts may be kept to only a few hundred model response-LLM prompt pairs. The administrative overhead for managing or curating model responses—such as the activities involved in choosing good model responses—is thus substantially curtailed. In a further improvement, elimination from the training data of model responses to prompts to generate text reduces overfitting to the model responses, allowing the LLM to improve its text generation ability without unnecessary constraints on the form of the text.

In one embodiment, the text generation tuning system implements a pipeline for LLM fine-tuning on text generation. In one embodiment, the text generation tuning system is a clear improvement over traditional techniques for LLM fine-tuning to improve text generation performance. Unlike traditional techniques which use prompt engineering or in-context learning to improve text generation ability of an LLM, in one embodiment, the text generation tuning system integrates use of specialized text generation training data with automated evaluation of iterative improvement to the LLM. In one embodiment, the pipeline implemented by the text generation tuning system uses customized text generation training data to fine-tune LLM weights for optimized text generation performance. Meanwhile, the pipeline uses automatic text generation evaluation to iteratively analyze the improvement/degradation of the fine-tuned LLM in order to obtain improved (e.g., optimized) LLM weights for text generation. In one embodiment, the text generation tuning system automatically evaluates and analyzes the ability of the LLM to generate text, thereby removing dependence on manual review of generated text for verification of the improvement and deployment decisioning.

### Definitions

As used herein, the term “fine-tuning” refers to the process of taking a pre-trained LLM and further training it on a specific task or domain—such as text generation—with a narrower dataset that is targeted to the specific task or domain.

As used herein, the term “natural language” (or “human language”) refers to a language that is used among humans for linguistic communication, such as a language that people use in everyday conversations, reading, and writing. Example natural languages include English, Spanish, Mandarin, Hindi, Arabic, and a wide variety of others. For purposes of this application, the term “natural language” includes classical languages such as Latin, Sanskrit, and Literary Chinese, and constructed or auxiliary languages such as Esperanto and Interlingua.

It should be understood that no action or function described or claimed herein is performed by the human mind. No action or function described or claimed herein can be practically performed in the human mind. An interpretation that any action or function described or claimed herein can be performed in the human mind is inconsistent with and contrary to this disclosure.

### Example Text Generation Tuning System for LLMs

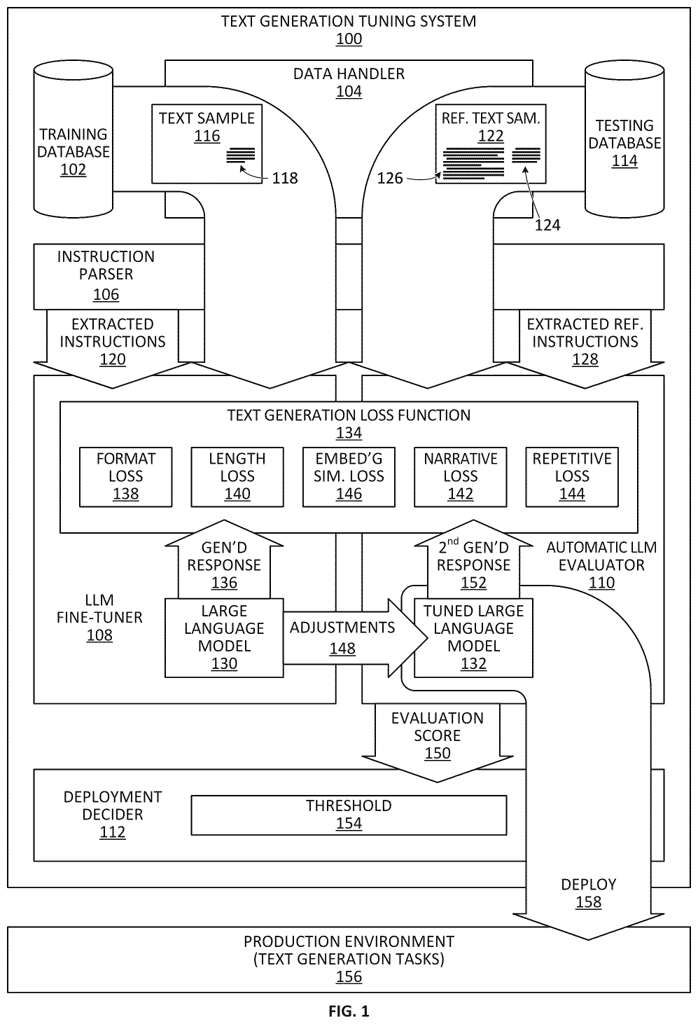

FIG. 1 illustrates one embodiment of a text generation tuning system 100 associated with automated LLM fine-tuning for text generation. Text generation tuning system 100 includes components for (i) automatically fine-tuning a LLM to generate outputs that more closely track expected natural language text responses to natural language requirements or instructions, (ii) automatically testing the extent to which the performance of the LLM has improved at the task of natural language text generation using a golden benchmarking dataset of text samples that specifically demonstrate satisfactory natural language text generation. In one embodiment, the components of text generation tuning system 100 include training database 102, data handler 104, instruction parser 106, LLM fine-tuner 108, automatic LLM evaluator 110, deployment decider 112, and testing database 114.

In one embodiment, data handler 104 is configured to access one or more collections of text samples, for example by establishing a connection to a database that holds the collection of text samples that is sought, executing queries to retrieve the text samples from the database, and storing the retrieved text samples for further analysis. Data handler 104 is configured to pass the stored text samples to instruction parser 106.

In one embodiment, data handler 104 is configured to access a collection of text samples 116 in training database 102. In one embodiment, data handler 104 is configured to access a collection of text samples 116. Text samples 116 are configured to be used for training an LLM for improved text generation performance, as described herein. A text sample 116 includes a text prompt 118. Text prompt 118 is written in natural language. Text prompt 118 includes instructions 120 (or requirements) combined with surrounding content. Text prompt 118 thus specifies both the text generation task to be performed by the LLM, and informational context in which the task is performed. Note that, in one embodiment, the text sample 116 lacks a model response to the text prompt 118.

In one embodiment, data handler 104 is also configured to access a collection of reference text samples 122 in testing database 114. Reference samples 122 are configured to be used for evaluating an LLM for improved text generation performance, as described herein. The reference text samples 122 from testing database 114 are designated as “golden” samples. The reference text samples 122 serve as benchmarks for evaluating the success of LLM-fine tuning to improve text generation performance. Reference text samples 122 include a corresponding pair of a reference text prompt 124 and a model response 126 to the reference text prompt 124. Like text prompt 118, reference text prompt 124 is written in natural language and includes combined instructions and content. The reference model response 126 is an exemplar body of text that demonstrates what a satisfactory response to the reference text prompt 124 would resemble or approximate. In other words, the reference model response 126 may be considered a “ground truth” response to the reference text prompt 124.

In one embodiment, instruction parser 106 is configured to parse text samples to extract instructions from the text prompt. For example, instruction parser 106 is configured to parse text samples 116 to extract the instructions 120 out of text prompt 118. And, instruction parser 106 is also configured to parse reference text samples 122 to extract reference instructions 128 out of reference text prompt 124 in a manner similar to that described below for extracting instructions 120 from text prompt 118.

In one embodiment, instruction parser 106 examines a text prompt 118 to separate instructions 120 to a LLM 130 from content of the text prompt 118 other than the instructions 120. The content may provide context or background information related to the instructions 120. In one embodiment, instruction parser 106 operates to identify as the instructions 120 those task descriptions, instruction segments, requirements, or other directive text within the text prompt 118 that outline actions to be taken on the remaining contextual, non-directive text. In one embodiment, instruction parser 106 stores the extracted instructions 120 in a data structure associated with the text sample 116. In one embodiment, instruction parser stores the other content of the text prompt 118 in a data structure associated with the text sample 116. The extracted instructions 120 and the other content are passed to LLM fine tuner 108 for use in operations to further train the LLM 130. (Similarly, extracted reference instructions 128 and reference content are stored in data structures associated with reference text samples 122, and are passed to automatic LLM evaluator 110 for use in operations to evaluate the state of fine-tuning for the tuned LLM 132).

In one embodiment, LLM fine-tuner 108 is configured to fine-tune a large language model 130 to generate text in natural language based on a text generation loss function 134. Text generation loss function 134 is configured to penalize non-compliance with one or more of the extracted instructions 120 by a generated text response 136 to the text prompt 118. In one embodiment, the text generation loss function 134 is further configured to reward relevance of the generated text response 136 to the text prompt 118, for example based on comparing embeddings of the generated text response 136 and the text prompt 118. In one embodiment, LLM fine tuner 108 is configured to improve the ability of the large language model 130 to generate natural language text responses that comply with instructions and are relevant to the prompt based on text generation loss function 134.

In one embodiment, text generation loss function 134 is configured to numerically quantify an effectiveness of the LLM 130 at a task of generating a body of natural language text in response to a given prompt. For example, text generation loss function 134 may be configured to generate one or more numerical values for various component loss analyses. In one embodiment, component loss analyses of text generation loss function 134 include format loss 138, length loss 140, narrative loss 142, repetitive loss 144, and embedding similarity loss 146. The values of a plurality of these component loss analyses may be merged, for example by a weighted or unweighted average, into an overall loss value output for text generation loss function 134.

In one embodiment, format loss 138 is configured to determine whether and/or to quantify to what extent the generated response 136 generated by the LLM complies with a format that is prescribed by an instruction, and to dock or penalize the text generation loss function 134 consistent with the extent of any noncompliance with the prescribed format. In one embodiment, format loss 138 is configured to generate a value of format loss that indicates an extent to which the generated text response complies with one or more of the extracted instructions that specify a format of the generated text response.

In one embodiment, length loss 140 is configured to determine whether and/or to quantify to what extent the generated response 136 generated by the LLM complies with a word count, sentence/paragraph length, or other constraint on length of the text, and to dock or penalize the text generation loss function 134 consistent with the extent of any noncompliance with the specified constraint on length. In one embodiment, length loss 140 is configured to generate a value of length loss that indicates an extent to which the generated text response complies with one or more of the extracted instructions that specify a length of the generated text response.

In one embodiment, narrative loss 142 is configured to determine whether and/or to what extent the generated response 136 is in a specified narrative perspective, and to dock or penalize the text generation loss function 134 consistent with the extent of any noncompliance with the specified narrative perspective. In one embodiment, narrative loss 142 is configured to generate a value of narrative loss that indicates an extent to which the generated text response complies with one or more of the extracted instructions that specify a narrative perspective of the generated text response.

In one embodiment, repetitive loss 144 is configured to determine whether and/or to what extent the generated response 136 has repetitive contents, and to dock or penalize the text generation loss function 134 consistent with the extent of any repetitiveness. In one embodiment, repetitive loss 144 is configured to generate a value of repetitive loss that indicates an extent to which one or more portions of the generated text response substantially repeat.

In one embodiment, embedding similarity loss 146 is configured to determine to what extent the generated response 136 is relevant to text prompt 118, and to dock or penalize the text generation loss function 134 consistent with the extent of irrelevance. In one embodiment, embedding similarity loss 146 is configured to determine the relevance by determining the similarity between vector embeddings of text prompt 118 and generated response 136. In one embodiment, embedding similarity loss 146 is configured to generate a value of embedding similarity loss that indicates an extent to which the text of the generated response 136 is contextually relevant to and aligned with the text of the text prompt 118.

Here, the embedding similarity loss between generated response and prompt quantifies how well the semantic content of the prompt was understood by the LLM, as reflected in the contextual relevance of the generated response. High embedding similarity between prompt and generated response indicates that the LLM accurately captured the semantic nuances of the prompt and the intentions behind the prompt. Further, high embedding similarity between prompt and generated response indicates that the generated response is likely to be a relevant and coherent response to the prompt, indicating the generated response is contextually appropriate and logically connected to the prompt.

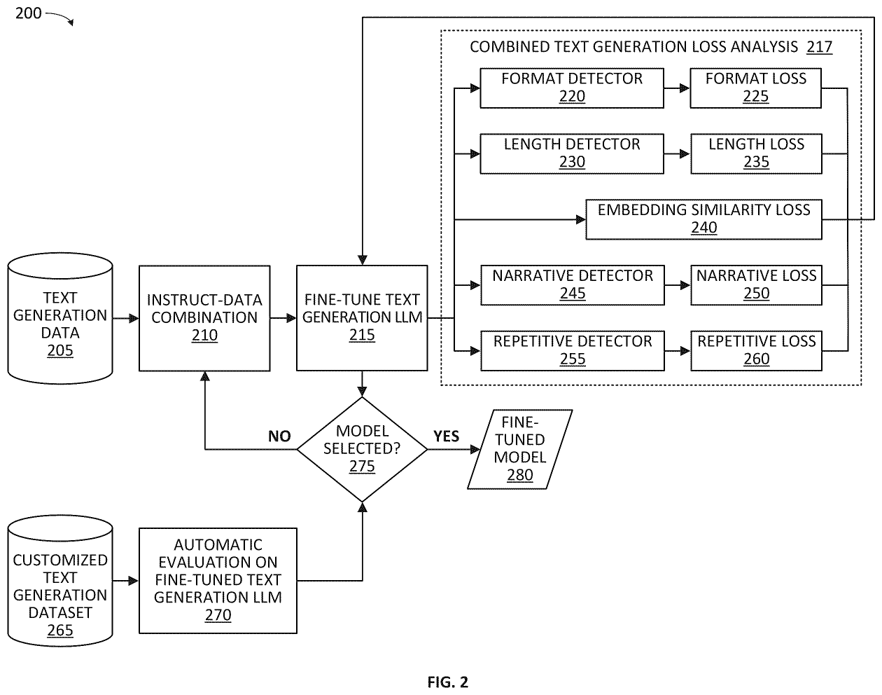

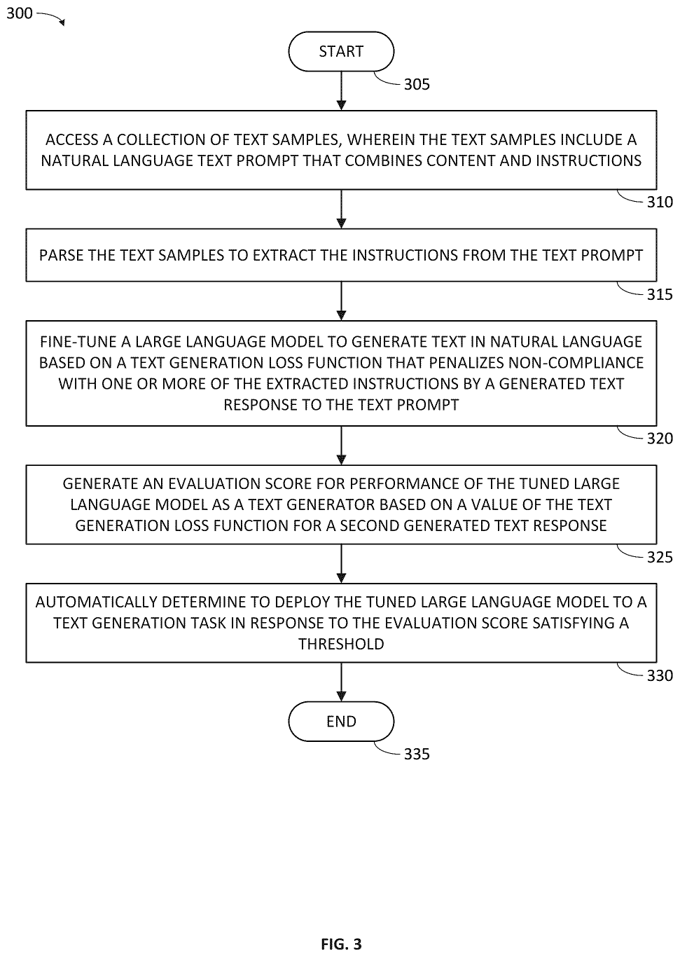

The foregoing component loss analyses are described in further detail below, for example with reference to combined text generation loss analysis 217 of FIG. 2, and blocks 320 and 325 of FIG. 3.

In one embodiment, text generation loss function 134 is configured to prompt an additional large learning model to evaluate one or more of the component loss analyses. For example, text generation loss function 134 may be configured to automatically generate and submit a prompt to the additional large language model that requests generation of one or more of a loss value for format loss 138, a loss value for length loss 140, a loss value for narrative loss 142, or a loss value for repetitive loss 144. The prompt may include any instructions for format, length, or narrative, the generated response 136, and a pre-formatted request to score the generated response 136 for compliance with the various instructions. And, text generation loss function 134 may be configured to automatically generate and submit a prompt to the additional large language model that requests generation of a loss value for repetitive loss 144. The prompt may include the generated response 136, and a pre-formatted request to score the generated response 136 for how repetitive it is. This causes the additional large language model to respond by generating the one or more loss values. Text generation loss function 134 is configured to parse the response from the additional large language model to extract the one or more loss values. Text generation loss function 134 is configured to incorporate the resulting scores into the text generation loss value for the generated response 136.

Format loss 138, length loss 140, and narrative loss 142 are loss analyses that may be associated with obedience to particular types of instructions in the text prompt 118. For example, where the text prompt 118 instructs a cap on word count in the generated response 136, the extent of compliance with that instruction is evaluated by length loss 140. In one embodiment, text generation loss function may include as components various other instruction loss analyses (not shown) that are associated with other types of instructions regarding the generated text. For example, instructions may specify the desired tone or writing style for the generated text, such as formal, casual, academic, persuasive, humorous, or technical. In another example, instructions may specify vocabulary (i) for use or avoidance in the generated text to ensure alignment with the domain or context of the generated text, or (ii) within a given reading grade level. In another example, instructions may specify tailoring the text to a given audience, considering factors such as age, interests, cultural background, or level of expertise. And, in another example, instructions may specify which information should be included or excluded from the generated text. Loss analyses for tone and style, vocabulary usage, target audience, inclusion/exclusion of specific information, or other characteristics of the generated text may be made in a manner similar to the format loss 138, length loss 140, and narrative loss 142 analyses. These additional instruction loss analyses operate to determine an extent to which the generated text complies with these other types of instructions.

In one embodiment, LLM fine-tuner 108 is configured to update, adjust, optimize, further train or otherwise fine-tune large language model 130 so as to improve performance of LLM 130 at the task of text generation. In other words, LLM fine-tuner 108 is equipped to tailor a configuration of LLM 130 for more accurate (e.g., human-like) text generation. LLM fine-tuner 108 is configured to fine-tune LLM 130 based on the text generation loss output of text generation loss function 134. The text generation loss outputs combined values of format loss 138, length loss 140, embedding loss 146, narrative loss 142, and repetitive loss 144, for example in a weighted average. In one embodiment, LLM-fine tuner 108 may be configured to generate adjustments 148 to weights (and/or other parameters) of large language model 130. LLM fine tuner 108 is configured to generate adjustments 148 that improve performance of large language model 130 with respect to text generation, based on one or more text samples 116 and the extracted instructions 120 obtained from the text samples 116. LLM fine tuner 108 is configured to produce adjustments 148 to large language model 130 so as to minimize text generation loss function 134 over the course of training.

In one embodiment, LLM fine tuner 108 is configured to generate adjustments 148 to the weights (and/or other parameters) of LLM 130 by backpropagation. LLM fine-tuner 108 is configured to iteratively adjust weights of LLM 130 in response to text samples 116 and the extracted instructions 120 extracted from the text samples 116 over an epoch of training. The epoch of training includes one or more text samples 116 with corresponding extracted instructions 120. Extracted instructions 120 obtained from an individual text sample 116—that is, extracted instructions 120 that are drawn from the text prompt 118 of the individual text sample—may be said to “correspond to” the individual text sample 116, such that an individual text sample 116 has a set of zero or more corresponding extracted instructions 120. The adjustments 148 may thus be a series of updates or changes to weights of nodes of the LLM 130 (or other parameters). LLM fine tuner 108 is configured to apply the adjustments 148 to the LLM 130 to create a re-trained, updated, or otherwise “tuned” LLM 132 at the end of an epoch of training. LLM fine-tuner 108 submits the tuned LLM 132 to automatic LLM evaluator 110 for evaluation of the ability of tuned LLM 132 to generate text.

In one embodiment, automatic LLM evaluator 110 is configured to generate an evaluation score 150 for performance of the tuned large language model 132 as a text generator. Automatic LLM evaluator 110 is configured to generate evaluation score 150 based on based on a value of the text generation loss function 134 for a second or additional generated text response 152. Evaluation score 150 (or other metrics) characterize or quantify the performance of tuned LLM 132. For example, automatic LLM evaluator 110 may be configured to generate one or more metrics for the performance of the tuned LLM 132 based on a reference text sample 122 from testing database 114. The additional generated text response 152 is generated by the tuned LLM 132 from a reference text prompt 124 of reference text sample 122. The additional generated text response 152 is generated to be a specimen that demonstrates the behavior of the tuned LLM 132 following fine-tuning away from the initial LLM 130. Extracted reference instructions 128 are obtained from the reference text prompt 124 in a manner similar to that described above for acquiring extracted instructions 120 from text prompt 118. Automatic LLM evaluator 110 is configured to execute text generation loss function 134 to obtain a loss value for the additional generated text response 132.

In one embodiment, automatic LLM evaluator 110 is configured to provide to text generation loss function 134 inputs of the additional generated text response 152, extracted reference instructions 128, and reference model response 126; and then to execute text generation loss function 134 on these inputs to produce the loss value. In one embodiment, the evaluation score 150 is based on the value of text generation loss resulting from execution of the text generation loss function 134 on these inputs corresponding to reference text sample 122. For example, evaluation score 150 may be the assigned the value of text generation loss for the reference text sample 122 that is given by the text generation loss function 134.

Automatic LLM evaluator 110 is configured to execute text generation loss function 165 to determine how well the additional generated response 152 complies with the extracted reference instructions 128. For example, format loss 138 is configured to produce a format loss value that quantifies compliance with one or more of the extracted reference instructions 128 that specify format of the additional generated text response 152. And, for example, length loss 140 is configured to produce a length loss value that quantifies compliance with one or more of the extracted reference instructions 128 that place one or more constraints on length of the additional generated response 152 or on lengths of subsections thereof. Also, for example, narrative loss 142 is configured to produce a narrative loss value that quantifies compliance with one or more of the extracted reference instructions that specify a narrative perspective of the additional generated response 152 or on subsections thereof.

In one embodiment, automatic LLM evaluator 110 is configured to execute text generation loss function 165 to determine how similar or dissimilar the additional generated response 152 to reference prompt 124 is from the reference model response 126 to reference prompt 124. Embedding similarly loss 146 is configured to embed both additional generated response 152 and reference model response 126 in respective vector representations of the two responses 152, 126. And, embedding similarity loss 146 is configured to produce a similarity loss value that quantifies similarity between the two embedded responses, such as a distance or angle between the vector representations.

In one embodiment, automatic LLM evaluator 110 is configured to execute text generation loss function 165 to determine how repetitive the additional generated response 152 is. Repetitive loss 144 is configured to produce a repetitive loss value that quantifies an extent to which portions of additional generated response 152 repeat in substance and/or language.

In one embodiment, automatic LLM evaluator 110 is configured to provide evaluation score 150 to deployment decider 112 for evaluation against a threshold 154 that controls whether to deploy 158 the tuned LLM 132 to a production environment 156.

In one embodiment, deployment decider 112 is configured to automatically determine to deploy 158 the tuned large language model 132 to a text generation task in the production environment 156 in response to the evaluation score 150 satisfying a threshold 154. Where the value of evaluation score 150 satisfies the threshold 154—that is, the condition(s) of threshold 154 evaluate to “TRUE” given the value of evaluation score 150—deployment decider 112 is configured to automatically deploy 158 tuned large language model 132 to perform text generation tasks in a production environment 156. Where the value of evaluation score 1150 does not satisfy the threshold 154—that is, the condition(s) of threshold 154 evaluate to “FALSE” given the value of evaluation score 150—deployment decider 112 is configured to not deploy tuned large language model 132 to perform the text generation tasks in the production environment. Instead, deployment decider 112 is configured to initiate a further epoch of training to further improve the tuned LLM 132.

In one embodiment, where higher values of text generation loss represent better performance of an LLM at text generation, threshold 154 is a minimum value for text generation loss for the tuned large language model 132. (In another embodiment, where lower values of text generation loss represent better performance of an LLM at text generation, threshold 154 is a maximum value for text generation loss for the tuned large language model 132.) Additional conditions may also be included in threshold 154.

In one embodiment, the threshold 154 is set, as a minimum, at a previous maximum evaluation score achieved by the LLM before fine-tuning. Where the evaluation metric(s) are improved over the previous maximum score for text generation, deployment decider 112 is configured to deploy 158 tuned LLM 132 to the production environment 156 to perform text generation tasks. In this manner, deployment decider 112 is configured to determine whether the tuned LLM 132 is sufficiently fine-tuned for deployment.

In one embodiment, deployment decider 112 is configured to automatically determine whether to deploy 158 the tuned large language model 132 to perform text generation tasks in response to the evaluation score 150 exceeding (or otherwise satisfying) a threshold 154. For example, deployment decider 112 is configured to automatically deploy 158 an LLM by accepting or selecting the LLM for promotion to operation in a live or production environment 156. In one embodiment, deployment decider 112 is configured to automatically carry out the promotion of the LLM to the production environment 156. For example, the deployment decider 112 is configured to integrate the tuned LLM 132 into the production environment 156 by automatically updating the model serving infrastructure, application programming interfaces (APIs), and/or other components used for operating the LLM to generate text.

In one embodiment, deployment decider 112 is configured to automatically generate a signal that is determinative as to whether to deploy 158 the tuned large language model 132 to production environment 156, or to initiate further rounds of training for the tuned large language model 132. For instance, deployment decider 112 is configured to automatically generate a trigger signal that indicates that fine tuning of the tuned large language model 132 is complete. And, an automated deployment of the tuned large language model 132 to a production environment may also be configured to be initiated in response to receipt of the trigger signal. Further, deployment decider 112 may automatically generate a retune signal that indicates that fine tuning of the tuned large language model 132 is not yet complete. And, further training of the tuned large language model 132 may also be configured to be initiated in response to receipt of the retune signal.

The automated deployment process rolls the tuned large language model 132 out to production environment 156 to replace or supersede a prior text generation LLM. As examples, the prior LLM may be an earlier training version of tuned LLM 132 (for example, LLM 130), or an alternative LLM configured for text generation that has a training history that differs from or is discrete from that of tuned LLM 132 or LLM 130. In one embodiment, deployment decider 112 is configured to automatically execute steps to replace the prior LLM in the production environment 156 with the tuned LLM 132. In one embodiment, the steps for automated deployment are performed by another component or module of text generation tuning system 100 in response to direction by the deployment decider 112 (for example, in response to the trigger signal. The automated deployment of the tuned LLM 132 minimizes disruption to the production environment 156 while incorporating the improved text generation ability of tuned LLM 132. In one embodiment, deployment decider 112 is configured to automate deployment of the tuned LLM 132 by a process of administrator confirmation (optional), model serialization, and API integration.

As an optional initial step, an administrator is presented with a choice to confirm or reject the automated deployment of tuned LLM 132 into the production environment 156. For example, the choice may be presented as a user-selectable option (such as a button) in a graphical user interface to text generation tuning system 100.

In one embodiment, deployment decider 112 then proceeds to serialize the tuned LLM 132. Prior to serialization, tuned LLM 132 is represented as an object, such as a Python object. Deployment decider 112 encapsulates the architecture, learned weights for improved text generation performance, and other parameters of the tuned LLM 132 into a serialized format for storage as a data structure. For example, deployment decider 112 accesses and executes a serialization function (such as ‘dump( )’ in the ‘joblib’ library for the scikit-learn ecosystem) on the tuned LLM 132. Similar serialization functions are available in other machine learning ecosystems. The serialized, tuned LLM 132 may be loaded into memory or otherwise accessed from the serialized data structure. The serialized, tuned LLM 132 is written to a specified storage location accessible by the production environment 156.

In one embodiment, deployment decider 112 then integrates the serialized, tuned LLM 132 into an existing API infrastructure for the production environment. Deployment decider updates the existing API endpoints and functionality to accommodate the tuned LLM 132. In one embodiment, discrete endpoints are defined to support various natural language processing tasks or functionalities. In one embodiment, there is a text generation endpoint dedicated to text generation tasks. The text generation endpoint accepts parameters such as prompts or seed text for generation of text, and in some cases, lengths of the text to be generated, probability ranges for sampling words (top-k sampling), and randomness of word selection (temperature). For example, the endpoint path may be ‘/generate_text’.

Deployment decider 112 updates code for the text generation endpoint in the production environment 156. The updates change the code for the text generation endpoint to load the serialized, tuned LLM 132, rather than the serialized prior LLM. For example, the code for the text generation endpoint is modified to (i) initialize the serialized, tuned LLM 132 (rather than initializing the prior LLM) from the specified storage location, and (2) direct incoming text generation requests to be handled by the initialized, tuned LLM 180 (rather than directing tasks to the prior LLM). Access to the prior LLM through the text generation endpoint is discontinued by removal of code to initialize or direct requests to the prior LLM, and the serialized prior LLM may be removed from the production environment 156. In one embodiment, the changes to the code of the text generation endpoint are managed by a version control system to allow for consistent deployment to the production environment, and allow for roll-back of the changes. In this way, the tuned LLM 132 that has been fine tuned to improve text generation may be automatically rolled out to the production environment 156.

Further details regarding text generation tuning system 100 are presented herein. In one embodiment, the operation of text generation tuning system 100 to fine tune the LLM for a text generation task will be described with reference to text generation tuning pipeline 200 shown in FIG. 2 and example text generation tuning method 300 shown in FIG. 3.

### LLM Fine-Tuning for Text Generation

As discussed above, a LLM may be configured to generate natural language text. Given a specific condition or context, an LLM-based text generator generates human-like textual content that conveys meaning, follows grammatical rules, and maintains context and coherence.

Text generation ability of LLM may be enhanced by evaluating the ability of the LLM to comply with natural language requirements or instructions. In one embodiment, a text generation tuning system (such as text generation tuning system 100) implements a process or pipeline to fine tune an LLM for the text generation task. The text generation tuning system is configured to automatically improve text generated by the LLM-based text generator. In order to improve the text generation ability of the LLM, text generation training data and a training loss function that are specific to text generation are used to further fine tune the LLM. In one embodiment, the training loss function penalizes non-compliance with one or more of the extracted instructions, causing the LLM to improve its ability to comply with the instructions. Thus, in one embodiment, the LLM is not dependent on model responses to the prompts in order to improve performance as a text generator.

As an example of LLM-based text generation, given natural language requirements or instructions that are input to the LLM, the LLM operates to generate text that follows the requirements or instructions as its output. Examples of text generation data is shown in Table 1 below:

TABLE 1

| Example | |
|---|---|
| Description | Example Input/Output |
| Example 1: | Input (text prompt): |
| A text generation | “Can you tell me more about transformers in deep learning?” |
| scenario which is | Example Output (model response): |
| tested by the ability | “In deep learning, transformers are a type of neural network that are |
| to follow | used to transform input data into a specific format. They are often |
| instructions. | used in natural language processing tasks, such as language |
| Example 1 may be | translation and text summarization. Transformers are typically |
| used for testing an | composed of multiple layers of neural networks that are used to |
| LLM for fine-tuning. | perform complex computations on the input data. The layers of |
| Both an input (text | transformers are typically stacked on top of each other, with each |
| prompt) and an | layer performing a specific type of transformation. The output of each |
| Example Output | layer is then passed to the next layer, which performs a different type |
| (model response). | of transformation. This process continues until the final layer, which |
| | produces the final output.” |
| Example 2: | Input (text prompt): |
| A text generation | <Instructions> Based on the {Description}. The description should: 1. include |
| scenario including | keywords for higher SEO ranking 2. be a maximum of 280 words 3. have |
| instructions | multiple sections for Product Description, Key Features, and Benefits. 4. |
| specifying length | format the key features and benefits sections in a bulleted list 5. Highlight the |
| and format of | keywords for SEO ranking in bold </Instruction> |
| output. | <description> Abdominal Binder with Wide Elastic Design For Optimal |
| A prompt to | Support, Plus-Size Fit, Post-Surgery Recovery, And Adjustable Closure |
| automatically | </description> |
| generate one or | Abdominal Binder with Wide Elastic Design For Optimal Support, Plus-Size |
| more unique | Fit, Post-Surgery Recovery, And Adjustable Closure is a revolutionary support |
| product descriptions | garment designed for post-surgery recovery and beyond. Its wide elastic |
| based on certain | design provides optimal support and stability for the abdominal region, making |
| characteristics | it suitable for individuals of all body shapes and sizes. The Plus-Size Fit |
| (content) provided. | ensures maximum comfort and effectiveness, while the Adjustable Closure |
| Example 2 may be | system offers customizable compression for a snug and secure fit. The binder |
| used for training in | also serves as a versatile companion for various activities, providing additional |
| the fine-tuning | core support and stability. Its discreet design allows for comfortable wear |
| process. No | under clothing, ensuring a smooth recovery process. Embrace the Ultimate |
| Example Output | Abdominal Binder as your dependable partner for the best abdominal support |
| (model response) is | and bid discomfort farewell. |
| provided. | Key Features: |
| | Wide Elastic Design: The 12-inch width of this abdominal binder ensures it can |
| | provide comprehensive coverage and support to a larger area of the abdomen. |
| | Plus-Size Fit: This specific abdominal binder is designed to accommodate |
| | plus-size men and women, ensuring a snug and comfortable fit for individuals |
| | with larger waist circumferences. |
| | Post-Surgery Support: It is particularly useful after certain surgeries like hernia |
| | surgery, c-section, or natural birth. It aids in reducing post-operative swelling, |
| | providing gentle pressure to the surgical site, and promoting faster healing and |
| | recovery. |
| | Adjustable Closure: Most abdominal binders come with adjustable closures, |
| | such as hook-and-loop fasteners or adjustable straps, allowing the user to |
| | customize the compression level and ensure a secure and comfortable fit. |
| | Benefits: |
| | Pain Relief: The compression provided by this abdominal binder can help |
| | alleviate pain and discomfort associated with abdominal injuries or surgery. It |
| | can reduce the pressure on the injured area and offer a sense of stability and |
| | security. |
| | Body Contouring And Confidence: This abdominal binder can give plus-size |
| | men and women a smoother appearance under clothing, helping boost their |
| | confidence during the recovery phase. |
| | Prevention Of Muscle Atrophy: This abdominal binder can help maintain some |
| | muscle tone by providing support, which may prevent muscle atrophy to some |
| | extent. |
| | Material Quality: High-quality elastic and sturdy stitching can contribute to |
| | better durability. |

In one embodiment, at a high level, the text generation tuning system implements a technique to fine-tune LLM for the text generation task. The technique implemented by the text generation tuning system is different from training-free techniques such as prompt tuning or in-context learning. Instead, the text generation tuning system fine-tunes the LLM with customized text generation data so that the weights of the LLM are changed to improve the text generation ability. Meanwhile, a novel fine-tuning loss function design encourages the LLM to generate human-like textual content that conveys meaning, follows grammatical rules, and maintains context and coherence. The text generation tuning system also employs an automatic evaluation process to quantify LLM's text generation performance.

FIG. 2 illustrates an example text generation tuning pipeline 200 for fine-tuning an LLM-based text generator. FIG. 2 provides a general overview of LLM text generation fine-tuning. In one embodiment, there are two main parts in text generation tuning pipeline 200: fine-tuning and auto-evaluation. In one embodiment, text generation data specifically targets various forms of text responses, including question answer, instruction following, and storytelling. The text generation data is used to fine-tune text generation ability of the LLM with a training process. The fine-tuning uses a novel loss function design (described in further detail elsewhere herein). The fine-tuned model is then processed by an automatic evaluation pipeline that is specifically configured for evaluating LLM text generation. If the model satisfies designated selection metrics, the fine-tuned model will be selected to output. If not, the pipeline will trace back to the fine-tuning stage and keep fine-tuning the LLM with text generation task(s) to get a better-tuned model.

In one embodiment, the fine-tuning part of text generation tuning pipeline 200 includes text generation data 205, instruction-data combination 210, fine tuning for text generation 215, format detector 220, format loss function 225, length detector 230, length loss function 235, embedding similarity loss function 240, narrative detector 245, narrative loss function 250, repetitive detector 255, and repetitive loss function 260. And, the auto-evaluation part of text generation tuning pipeline 200 includes testing dataset for text generation 265, automatic evaluation on fine-tuned text generation 270, and model selection for code generation 275. In one embodiment, text generation tuning pipeline 200 produces a fine-tuned model for text generation 280 as output.

In one embodiment, text generation data 205 includes a plurality of text samples (such as text samples 116). The text samples include bodies of text content that are combined with instructions about or related to the text. In one embodiment, the text samples are composed in natural or human language. In one embodiment, the text samples include text prompts (such as text prompt 118) that are configured to be processed by an LLM. The text prompts include a natural language body of text content and human language instructions for handling the text content. The sample of text may include both an instruction and a body of information in a natural language statement. For example, the text “Can you tell me more about transformer in deep learning?” (as in Example 1 in Table 1 above) includes both an instruction “Can you tell me more about”, and a body of content “transformer in deep learning?” In one embodiment, the text sample is configured to indicate that the text prompt is an input for an LLM, and that the model text response is an expected output (or “ground truth”) of the task of generating text from the prompt that follows the instructions in the prompt. For example, the prompt indicated to be “input” and the response described as “example output” as shown in Table 1 above. The text samples may be used to train the LLM to generate text that mimics human text composition.

In one embodiment, instruction-data combination 210 is a handler or parser configured to separate content from an instruction about the content in a given text sample. In one embodiment, instruction-data combination 210 prepares data for LLM analysis by extracting or otherwise un-combining the instructions and other data/content in a given text prompt 118. In one embodiment, the instruction-data combination 210 parses a text sample 116 to identify, separate, and/or extract instructions from the body of a text prompt 118 included in the text sample 116. In one embodiment, instruction-data combination 210 preprocesses the text prompts 118 to identify instructions regarding output format, output length, and/or narrative perspective of the output. These instructions may be stored individually with an indication that a given instruction relates to format, length, or narrative perspective. Additional detail regarding the extraction of instructions from the text prompt is described with reference to block 315 of text generation tuning method 300 and instruction parser 106.

In one embodiment, fine tuning for text generation 215 is configured to train the LLM to generate textual content that is more humanlike while complying with grammatical rules, coherence, and context. Fine tuning for text generation 215 operates to adjust performance of the LLM at a task of generating written material in response to a prompt. The training process is based on a novel combined text generation loss analysis 217 incorporating format detector 220, format loss function 225, length detector 230, length loss function 235, embedding similarity loss function 240, narrative detector 245, narrative loss function 250, repetitive detector 255, and repetitive loss function 260. The components 220-260 of the combined text generation loss analysis 217 quantify various ways in which software-generated text generated by the LLM deviates from the ground truth text of the model response included in the text samples 118. Thus, in one embodiment, text generation tuning pipeline 200 combines a variety of loss functions to provide more informative feedback on updates to the model.

In one embodiment, fine tuning for text generation 215 trains the LLM to mimic human text generation through one or more epochs of the text samples. During the training, weights of the LLM are adjusted iteratively (e.g., by backpropagation) to minimize the combined text generation loss analysis 217. At the conclusion of a training epoch, the trained LLM will be evaluated as discussed at blocks 240 and 245 below.

In one embodiment, format detector 220 is configured to determine whether text generated by the LLM complies with a format that is prescribed by an instruction identified by instruction-data combination 210. In one embodiment, the format detector 220 is a model separate from the LLM that is specialized in format checking. In one embodiment, whether or not text generated by the LLM complies with a format that is prescribed by an instruction is a binary true/false analysis. Format detector 220 may determine whether or not a formatting instruction is followed in a generated response for zero or more formatting instructions, depending on how many formatting instructions were extracted out of a text prompt used to generate the generated response.

For example, if the instruction specifies that the LLM is to generate a response having information presented in the format of a numbered list, format detector 220 will check if the numbered list format is satisfied in the generated response. Or, for example, if the instruction specifies that the LLM is to generate a response with one paragraph dedicated to each of N topics, format detector will check that the prescribed paragraph-per-topic format is satisfied in the generated response. Or, in another example, if the instruction specifies that the LLM is to output json format output, format detector 220 will check if json format is satisfied in the generated response. Or, in Example 2 of Table 1 above, one format instruction specifies that the generated response should have multiple sections for product description, key features, and benefits. Another format instruction specifies that the generated response should format the key features and benefits sections in a bulleted list. And, a further instructions specifies that keywords should be highlighted in bold. Format detector 220 will check whether (i) the specified sections were included in the generated response; (ii) the specified sections include bulleted lists; and (iii) the keywords are highlighted in bold.

In one embodiment, format loss function 225 is configured to assign a penalty where format instructions are not followed. In one embodiment, assignment of a penalty includes an analysis of the extent to which the format is satisfied, for example with a score for format loss normalized between zero and 1. In one embodiment, the score, penalty, or other value for format loss may be obtained by prompting an additional LLM to generate the value for format loss based on inputs of a formatting instruction and the generated output. Where multiple formatting instructions are extracted from the text prompt, the values of format loss for individual formatting instructions may be averaged to produce a merged, overall value of formatting loss.

In one embodiment, length detector 230 is configured to determine whether text generated by the LLM complies with a word count, sentence/paragraph length, or other constraint on length of the text. In one embodiment, the length detector 230 is a rule engine separate from the LLM that is configured to apply rules or heuristics to validate that the length constraints are satisfied by a text. Length detector 230 checks lengths of words, sentences, paragraphs, other portions of and/or the entirety of the generated response. To determine compliance, length detector 230 may count characters, tokens, words, phrases, or other text elements specified by an instruction, and compare that to a maximum (cap), minimum (floor) or other constraint specified by the instruction. In one embodiment, the constraint on length may be included in the instructions. In one embodiment, whether the constraint on length is a binary true/false analysis.

For example, length detector 230 will check if the generated output satisfied the length requirement if the prompt specifies that the LLM generate a certain sentence length. In Example 2 of Table 1, the instructions specify a maximum of 280 words for the generated output. Length detector 230 will check if the generated output has 280 words or fewer.

In one embodiment, length loss function 235 is configured to assign a penalty where the length constraint is not satisfied. In one embodiment, assignment of a penalty includes an analysis of the extent to which the length constraint is satisfied, for example with a score for length loss normalized between zero and 1. In one embodiment, the score, penalty, or other value for length loss may be obtained by prompting an additional LLM to generate the value for length loss based on inputs of a length instruction that specifies the length constraint and the generated output. Where multiple length instructions are extracted from the text prompt, the values of length loss for individual length instructions may be averaged to produce a merged, overall value of length loss.

In one embodiment, embedding similarity loss function 240 is configured to quantify how dissimilar the text of the generated response is from the text prompt in terms of semantic content. In other words, embedding similarity loss function 240 measures semantic divergence by the generated text from the text prompt. To measure the extent of semantic divergence (or alignment) closeness, embedding similarity loss function 240 embeds the LLM-generated output into a vector, and embeds the text prompt into another vector. In one embodiment, the text prompt and generated response are embedded at the word level. For example, embedding similarity loss function 240 converts the words of the text prompt and generated response into individual dense vectors per word. The word vectors for the text prompt and for the generated response may then be respectively merged by vector arithmetic to capture single-vector semantic vector representations for both the text prompt and the generated response. Both the generated response and the text prompt from which the response was generated are thus mapped into a vector space.

Then, embedding similarity loss function 240 generates a similarity metric that quantifies the difference between the alignments of the text prompt and generated response in the vector space. In one embodiment, embedding similarity loss function 240 calculates a cosine distance between the two vectors as the similarity measurement. In one embodiment, the embedding similarity loss function 240 outputs the resulting cosine distance as the value of embedding similarity loss between the generated output and the text prompt. The closer the content of the generated response is semantically to the text prompt, the less the loss. Embedding similarity loss function 240 thus, in one embodiment, compares the generated response to the text prompt to measure the semantic divergence between the two texts.

In one embodiment, other measures of similarity may be used for comparison of the generated response with the text prompt. For example, the cosine of the angle between the two vectors may be used, and ranges from −1 (completely dissimilar) to 1 (identical). (Note, the cosine distance (discussed above) is the complement of the cosine of the angle between the two vectors.) Or for example, the Euclidean distance (straight-line distance) in the vector space between the endpoints of the two vectors may be used, and ranges from 0 (identical) to infinity (completely dissimilar).

In one embodiment, narrative detector 245 is configured to detect whether the generated text is in a specified narrative perspective. For example, if the prompt requires LLM to generate text using a certain narrative perspective (First/Second/Third person), narrative detector 245 will check if the generated output satisfied the narrative requirement. In one embodiment, this is a binary true/false analysis. A narrative instruction that specifies a narrative perspective may specify that it is applicable to a given portion of the generated text. Narrative detector 245 may determine whether or not a narrative instruction is followed in a generated response for zero or more narrative instructions, depending on how many narrative instructions were extracted out of a text prompt that was used to generate the generated response.

In one embodiment, narrative loss function 250 is configured to assign a penalty where a specified narrative perspective is not used. In one embodiment, assignment of a penalty includes an analysis of the extent to which the specified portion of the generated text conforms to the specified narrative perspective, for example with a score for narrative loss normalized between zero and 1. In one embodiment, the score, penalty, or other value for narrative loss may be obtained by prompting an additional LLM to generate the value for narrative loss based on inputs of a narrative instruction and the generated output. Where multiple narrative instructions are extracted from the text prompt, the values of narrative loss for individual narrative instructions may be averaged to produce a merged, overall value of narrative loss.

In one embodiment, repetitive detector 255 is configured to check if, or to what extent, the generated output has repetitive contents. In one embodiment, detection of repetitiveness in generated text may be a binary true/false analysis. Or, in one embodiment, detection of repetitiveness in generated text may be a scalar or proportional analysis.

Repetitive detector 255 may analyze the generated response to the text prompt for repetitiveness using one or more of a variety of approaches. Repetitive detector 255 may perform a token frequency analysis of the generated text. Tokens that occur at high frequency in the generated text may indicate repetition, especially where high-frequency tokens occur multiple times in close proximity. Repetitive detector 255 may perform an analysis of n-grams (sequences of n consecutive tokens) in the generated text. Repeated n-grams, particularly repeated n-grams of higher lengths (values of n), may indicate repetitive patterns in the generated text. Repetitive detector 255 may perform an analysis of lexical diversity in the generated text, such as type-token ratio or Simpson's diversity index. Lower values for lexical diversity may indicate higher repetitiveness. Repetitive detector 255 may perform an analysis that compares sentences or paragraphs within the generated text. Similarity metrics such as cosine distance, precision (an extent to which words appear in the same order in two passages of text), and recall (an extent to which words or phrases in one passage of text also occur in another passage of text) may be used to identify duplicate or highly similar content. And, repetitive detector 255 may perform pattern matching techniques to identify recurring phrases, templates, or motifs. These and other repetition analyses may be combined in order to present a single value of repetitiveness, for example by normalization and weighted averaging of the individual analysis outcomes.

In one embodiment, repetitive loss function 260 is configured to assign a penalty based on the detected extent to which the generated output is repetitive. In one embodiment, the narrative and repetitive detection analyses may be performed by either rules engines or an LLM. In one embodiment, repetitive loss function 260 executes a rules engine to score the (non) repetitiveness of the generated text based on one or more of the analyses employed by repetitive detector 255. In one embodiment, repetitive loss function 260 prompts or asks another LLM to score the generated text for (non) repetitiveness.

In one embodiment, a rules engine is configured to generate a composite score for repetitiveness based on one or more of token frequency, n-gram, lexical diversity, cosine distance, recall, precision, and pattern matching analyses. The rules engine executes a set of pre-defined rules to generate scores for the given analyses. To score for repetitiveness using the rules engine, repetitive loss function separates or “tokenizes” the input text into individual tokens, provides the tokens as inputs to the particular analyses included in the repetitiveness analysis, accepts the output scores produced by the analyses as component scores, and integrates the component scores into a single-valued composite score for repetitiveness.

The rules engine may execute the token frequency analysis to provide a score for repetitiveness of the generated text by: (i) determining normalized frequencies of occurrence of the tokens individually; (ii) determining average (mean) normalized frequency across the tokens collectively; (iii) determining variance of the normalized frequencies around the average normalized frequency; and (iv) generating a repetitiveness score based on the average normalized frequency and variability of token frequencies, such as Repetitiveness=Average−Weight*Variance, where the Weight parameter adjusts the influence of the variance on the output. Higher scores indicate greater repeat occurrence of tokens in the generated text, and suggest higher repetitiveness.

The rules engine may execute the n-gram analysis to provide a score for repetitiveness of the generated text by: (i) determining normalized frequencies of occurrence for the set of possible n-grams (sequences of n-consecutive words) in the generated text; (ii) determining average (mean) normalized frequency of the set of possible n-grams; (iii) determining variance of the normalized frequencies around the average normalized frequency; and (iv) generating a repetitiveness score based on the average normalized frequency and variability of token frequencies, such as Repetitiveness=Average−Weight*Variance, where the Weight parameter adjusts the influence of the variance on the output. Higher scores indicate greater repeat occurrence of n-grams in the generated text, and suggest higher repetitiveness.

The rules engine may execute the lexical diversity analysis to provide a score for repetitiveness of the generated text by determining the inverse of the ratio of unique tokens to the total number of tokens in the generated text. Higher scores indicate lower diversity of unique words in the generated text, and suggest higher repetitiveness.

The rules engine may execute the cosine distance analysis to provide a score for repetitiveness of the generated text by: (i) representing individual sentences in the text as numerical vectors, for example using techniques like TF-IDF (Term Frequency-Inverse Document Frequency) to convert a sentence to vector representation; (ii) computing the cosine distance between pairs of sentence vectors; and (iii) averaging the cosine distances between the pairs to produce a repetitiveness score. Higher scores indicate greater dissimilarity between sentences of the generated text, and suggests higher repetitiveness. A similar analysis may be performed based on cosine similarity, rather than cosine distance.

The rules engine may execute the recall analysis to provide a score for repetitiveness of the generated text by: (i) determining a number of shared tokens that appear in both sentences of pairs of sentences from the generated text; (ii) determine a recall score for each pair of sentences, for example where recall=number of shared tokens/total number of tokens in a reference sentence in the pair of sentences; and (iii) averaging the recall scores for the pairs of sentences to produce a repetitiveness score. Higher scores indicate greater overlap of tokens between sentences of the generated text, and suggest higher repetitiveness.

The rules engine may execute the precision analysis to provide a score for repetitiveness of the generated text by: (i) determining lengths of shared sequences of tokens that appear in the same order in both sentences of pairs of sentences from the generated text; (ii) determine a precision score for each pair of sentences, for example where precision=length of shared sequences of tokens/total number of tokens in a reference sentence in the pair of sentences; and (iii) averaging the precision scores for the pairs of sentences to produce a repetitiveness score. Higher scores indicate greater overlap in tokens and token order between sentences of the generated text, and suggest higher repetitiveness.

The rules engine may execute the pattern matching analysis to provide a score for repetitiveness of the generated text by: (i) accessing pre-defined patterns (or regular expressions) that represent repetitive structures; (ii) searching the generated text using the patterns to identify occurrences of the defined patterns and counting the number of matches found for each pattern; (iii) generate a weighted sum of the match counts, with weights applied to counts for given patterns based on the relevance or significance of the pattern, to produce a repetitiveness score. Higher scores indicate greater occurrence of repetitive patterns in the in the generated text, and suggest higher repetitiveness.

In the foregoing analyses, higher scores indicate greater repetitiveness, while lower scores indicate more diversity, that is, less repetitiveness. In one embodiment, the component scores for the individual analyses are integrated into the composite score by normalizing the composite scores to normalized to a scale (e.g., between 0 and 1) in common; accessing pre-defined weights for each component score, combine the normalized scores using a weighted sum, weighted average, or other aggregation method to produce the composite score for repetitiveness.

In one embodiment, an additional LLM is configured to generate a composite score for repetitiveness in response to a prompt. In one embodiment, the additional LLM is an LLM other than the LLM currently being fine-tuned for text generation performance, such as a previously deployed iteration of the LLM being fine-tuned. For example, repetitive loss function 260 retrieves a pre-composed prompt regarding scoring for repetitiveness, and submits the prompt and the generated text to the additional LLM to cause the additional LLM to produce a score for repetitiveness of the generated text. The pre-composed prompt may be a template prompt. Repetitive loss function 260 stores the score for repetitiveness that was returned by the LLM. The scores produced by the LLM may be normalized to the range from 0 to 1 (where the scores produced by the LLM are not already normalized to the range from 0 to 1). For example, repetitive loss function 260 may prompt the additional LLM to score the generated output on the criterion of repetitiveness with a prompt such as: “Grade, on a scale from 0 to 100%, is the generated output repetitive?” In one embodiment, when generating a response to the prompt, the LLM may perform one or more of the repetitiveness analyses to generate the composite score in response to the prompt.

In one embodiment, testing dataset for text generation 265 (such as testing database 114) is a collection of text samples that include content and instructions in human language. In one embodiment, the text samples (such as reference text samples 122) of testing dataset of text generation 265 are discrete from and do not overlap the text samples in text generation data 205, thereby preventing overfitting. In one embodiment, the testing dataset of text generation 265 includes a few hundred to a few thousand text samples, for example, 1000 text samples.

In one embodiment, testing dataset of text generation 265 is a golden or benchmarking dataset. The golden data is used as a reference for testing text generation performance. In one embodiment, the golden data is formatted as pairs of input combined instructions and content and output example generated text, such as shown above with reference to Example 1 of Table 1. In one embodiment, the output example generated text may be human prepared model response, or computer-generated model responses that have been deemed (upon review) to be representative of acceptable responses to the instructions. For example, the output example generated text may exhibit acceptable loss scores under combined text generation loss function 217. In short, the golden data provides a reference, benchmark, or other standard demonstrating an expected quality level for generated text.

In one embodiment, automatic evaluation on fine-tuned text generation 270 (such as may be performed by automatic LLM evaluator 110) is configured to quantify how well the LLM performs as a text generation tool following training. In one embodiment, automatic evaluation on fine-tuned text generation 270 grades LLM-generated text using an additional LLM. In one embodiment, the generated text is graded by the additional LLM with respect to compliance with format instructions, compliance with length instructions, compliance with narrative instructions, repetitiveness, or various other criteria (or instructions) such as relevance, human-readability, conciseness, tone or style, vocabulary, audience, informativeness, and so on. In one embodiment, the LLM is prompted to generate scores for relevance of the generated output to the preceding prompt, repetitiveness of the generated output, conciseness of the generated output. Automatic evaluation on fine-tuned text generation 270 may also score the outputs based on compliance with instructions that specify format, length, narrative perspective, or other features of the generated output. For example, automatic evaluation on fine-tuned text generation 270 may prompt the additional LLM with instructions to score a generated response (such as second generated response 152)) regarding instructions extracted from a reference text prompt (such as reference text prompt 124) that was used to create the response. In one embodiment, each of these scores generated by the additional LLM is (i) normalized to the range of 0-1, (ii) optionally weighted to add or detract significance of an individual score, (iii) averaged across the plurality of text samples in the testing dataset of text generation 265, and (iv) averaged again between each other in order to produce a single evaluation score.

In one embodiment, model selection for text generation 275 (such as may be performed by deployment decider 112) may be configured to determine whether the LLM is sufficiently improved with regard to the text generation task to warrant promotion to a fine-tuned model for code generation 280, or not. If not, then text generation tuning pipeline 200 returns to fine tuning for code generation 215 for an additional training epoch using a further batch of code samples from text generation data 205, as processed by instruction-data combination 210. In one embodiment, the threshold for selecting an LLM to be a fine-tuned model for text generation 280 as output is whether the evaluation score exceeds a previous high for the evaluation score.

In one embodiment, model selection for text generation 275 is configured to determine whether the LLM has improved over its prior peak ability to generate text. In one embodiment, if the text generation performance of the LLM has improved, the LLM is to be considered to have satisfied the conditions (e.g., threshold 154) for being “fine-tuned” with respect to the text generation task. In another embodiment, the text generation performance is considered to satisfy the conditions for being “fine-tuned” where the improvement exceeds the prior peak by at least a pre-set ratio. Where the LLM is considered to be fine-tuned (275: YES), the tuned LLM (e.g., tuned LLM 132) is selected for deployment into a production environment (e.g., production environment 156) to generate further texts. If the LLM does not satisfy the conditions for being considered fine-tuned (275: NO), the text generation tuning pipeline 200 returns to block 210 for an additional epoch of training with further text samples. A “retune” signal indicating that the text generation tuning pipeline 200 should return to block 210 may be transmitted.

### Example Text Generation Tuning Method

FIG. 3 illustrates one embodiment of a text generation tuning method 300 associated with automated LLM fine-tuning for text generation. In one embodiment, text generation tuning method 300 is a technique to fine-tune an LLM in order to improve an ability of the LLM to generate text based on a prompt using on a collection of customized text generation data. In one embodiment, text generation tuning method 300 may implement an automatic evaluation pipeline that analyzes the text generation ability of an LLM that has been fine-tuned, such as text generation tuning pipeline 200 shown and described with reference to FIG. 2. The analysis is automatic, and based on an automatic metric calculation (such as in text generation loss function 134 or text generation loss analysis 217), thereby fully automating evaluation of text generation output.

In one embodiment, to fine-tune LLM weights of LLM 130 for optimized text generation ability, text generation tuning method 300 uses a custom set of training data, such as the collection of text samples 116, 122 held in training database 102 and testing database 114, respectively. The custom training data is curated for improving the performance of text generation. Text generation tuning method 300 implements an automated evaluation of text generation that iteratively analyzes the improvement (or degradation) of the fine-tuned LLM 132 over LLM 130 to obtain optimized (or more accurate) LLM weights for text generation.

In one embodiment, as a general overview, text generation tuning method 300 accesses a collection of text samples. The text samples include a natural language text prompt that combines content and instructions. Text generation tuning method 300 parses the text samples to extract the instructions from the text prompt. Text generation tuning method 300 fine-tunes a large language model to generate text in natural language. The fine-tuning is based on a text generation loss function that penalizes non-compliance with one or more of the extracted instructions by a generated text response to the text prompt. Text generation tuning method 300 generates an evaluation score for performance of the tuned large language model as a text generator. The evaluation score is generated based on a value of the text generation loss function for a second generated text response. And, text generation tuning method 300 automatically determines to deploy the tuned large language model to a text generation task in response to the evaluation score satisfying a threshold.

In one embodiment, text generation tuning method 300 initiates at START block 305 in response to an LLM tuning system determining that (i) an LLM has been submitted to the LLM tuning system to have its performance as a text generator fine-tuned; (ii) an instruction to perform the text generation tuning method 300 has been received by LLM tuning system; (iii) a retune signal has been received indicating that an LLM being fine-tuned has not yet satisfied a threshold for text generation performance; (iv) it is currently a time at which the text generation tuning method 300 is scheduled to be run; or (iv) that text generation tuning method 300 should commence in response to some other condition. In one embodiment, a computer system configured by computer-executable instructions to execute functions of text generation tuning system 100 and/or text generation tuning pipeline 200 executes the text generation tuning method 300. Following initiation at START block 305, text generation tuning method 300 continues to block 310.

At block 310, text generation tuning method 300 accesses a collection of text samples. The text samples include a natural language text prompt that combines content and instructions. Text generation tuning method 300 connects to a training database containing text samples that were selected for fine tuning the LLM. In one embodiment, each text sample includes a unique text prompt. The text prompts includes both instructions that direct generation of a text response to the prompt, and other content that provides the subject (or other context) for the text response to the prompt. In one embodiment, the content includes substantive information, ideas, descriptions, explanations, stories, data, messages, themes, facts, opinions, narratives or other subject matter expressed within the text prompt that does not direct the operation of the LLM. In one embodiment, the instructions include directives, commands, guidelines, requirements, or other content provided in the text prompt that indicate how the content should be interpreted, processed, or otherwise acted upon.

In one embodiment, to access the collection of text samples, text generation tuning method 300 (i) initializes a data handler component (such as data handler 104); (ii) establishes a connection to a training database (such as training database 102); (iii) retrieves a sufficient quantity of text samples (such as text samples 116) from the training database to be used for an epoch of training; (iv) parses the text samples to extract the natural language text prompt (such as text prompt 118); and (v) provides the text prompts to an instruction parser component for extraction of instructions from the body of the text prompts. In one embodiment, the quantity of text samples for the epoch of training are organized as a batch, for example by being placed into a data structure or array for subsequent processing. In this manner, the collection of text samples is accessed and the text samples are configured for subsequent operations to fine-tune the LLM.

In one embodiment, text generation tuning method 300 also (i) establishes a connection to a testing database (such as testing database 114); (ii) retrieves at least one reference text sample (such as reference text sample 122) from the testing database to be used for evaluation of text generation performance of the LLM after fine tuning; (iii) parses the reference text samples to extract a natural language text prompt (such as reference text prompt 124) and its corresponding model response (such as reference model response 126); and (iv) provides the reference text prompt to the instruction parser for extraction of instructions (such as extracted reference instructions 128) from the reference text prompt. The reference text prompt, the extracted reference instructions, and the model response will be provided as testing data for evaluating an epoch of training of the LLM. In this manner, the reference text samples are accessed and configured for subsequent operations to evaluate the fine-tuning of the LLM.

In one embodiment, the steps of block 310 are performed by data handler 104. At the conclusion of block 315, text generation tuning method 300 has accessed and retrieved text samples 116 for fine-tuning the LLM (and reference text samples 122 for evaluating the improvement) and extracted their respective text prompts 118, 124. Processing continues at block 315.

At block 315, text generation tuning method 300 parses the text samples to extract the instructions from the text prompt. Text generation tuning method 300 may separate the instructions and the content from the text prompt 118. Text generation tuning method 300 analyzes the text samples to isolate words and phrases within the text prompt that act as directives or command to the LLM. And, in one embodiment, text generation tuning method 300 determines the extracted instructions to be of particular types, such as instructions regarding format, length, narrative perspective, or a variety of other types of instructions.

In one embodiment, text generation tuning method 300 parses the text samples 116 to extract the instructions from the text prompt by using a sequence of natural language processing operations. For example, text generation tuning method 300 identifies a field (or other attribute) designated for the text prompt 118 in a given text sample 116, and extracts the text prompt 118 from the field. The text prompt 118 may be, for example, a string, linked list, array, or other data structure. Text generation tuning method 300 then tokenizes the text prompt 118 into basic units of text (called “tokens”), such as words and punctuation marks. Text generation tuning method 300 then analyzes the tokenized text prompt to identify keywords, grammatical structures, and/or semantic relationships between words and phrases, such as keywords, grammatical structures, or semantic relationships that indicate imperative verbs and phrases or question phrases. Such imperatives or questions are often indicative of instructions. Further, the verbs in these phrases often indicate the action that is instructed to be performed on content. Text generation tuning method 300 employs pattern recognition to identify the tokens involved in the structures and relationships that are indicative of instructions. Text generation tuning method 300 then selects as the instructions the tokens in the text prompt 118 that specify the task or request to be performed, and writes the selected tokens to a data structure for the instructions.

In one embodiment, the parsing detects instructions that are expressly labeled in the text prompt 118. For example, as shown in Example 2 of Table 1 above, the text prompt includes expressly labeled instructions—“<Instructions> Based on the {description}. The description should . . . </Instructions>”. In one embodiment, text generation tuning method 300 analyzes the tokenized text prompt to identify keywords, grammatical structures, and/or semantic relationships keywords that expressly label instructions. This may serve as an attention mechanism to direct the text generation tuning method 300 to consider the labeled portion for extraction of instructions using the natural language processing steps discussed above.

In one embodiment, the parsing distinguishes the instructions from expressly-labeled contextual content. For example, as shown in Example 2 of Table 1, the text prompt includes and expressly labeled content other than the instructions—“<description> Abdominal Binder . . . </description>”. In one embodiment, the parsing distinguishes the instructions from contextual content that is not labeled, for example, the large body of text following the labeled description.

In one embodiment, the text generation tuning method 300 determines an extracted instruction to be of a particular type of instruction, and then stores the extracted instruction in association with the particular type. In one embodiment, text generation tuning method 300 further analyzes individual instructions to determine whether they relate to one or more categories of loss analyzed by a text generation loss function (such as text generation loss function 134 or combined text generation loss analysis 217). Once text generation tuning method 300 has extracted instructions, text generation tuning method 300 further analyzes the instructions for patterns or keywords related to characteristics of the output. For example, a pattern in the instruction such as “in under [number] words . . . ” is detected to be an instruction specifying a length of the response output by the LLM.

As another example, a pattern in the instruction such as “in a dialogue, . . . ” is detected to be an instruction specifying a narrative perspective of the response output by the LLM. In one embodiment, text generation method 300 will then store the information that the extracted instruction as an instruction of a particular type, such as relating to characteristics such as format, length, and narrative perspective, etc. For example, the extracted instruction may be labeled or tagged as being of a particular type by setting a flag associated with the characteristic to indicate “TRUE” for the extracted instruction.

Thus, in one embodiment, text generation tuning method 300 parses the text samples to extract the instructions from the text prompt by (i) initializing an instruction parser (such as instruction parser 106) to perform the steps of block 315; (ii) accessing the text prompt from the text sample; (iii) tokenizing the accessed text prompt; (iv) analyzing the tokenized text to identify grammatical structures, semantic relationships, and/or keywords that are indicative of instructions; (v) selecting tokens that make up the identified grammatical structures, semantic relationships, and/or keywords as the instructions; (vi) storing the selected instructions in a data structure that associates the instructions with the text prompt; and (vii) optionally, classifying the instructions by type, such as instructions related to format, length, and narrative perspective.

In one embodiment, the steps of block 315 are performed by instruction parser 106. At the conclusion of block 315, text generation tuning method 300 has identified and extracted instructions 120 from the text prompt 118, and processing continues at block 320.

At block 320, text generation tuning method 300 fine-tunes a large language model (e.g., large language model 130) to generate text in natural language. The fine tuning is based on a text generation loss function (e.g., text generation loss function 134) that penalizes non-compliance with one or more of the extracted instructions (e.g., extracted instructions 120) by a generated text response (e.g., generated response 136) to the text prompt (e.g., text prompt 118). Text generation tuning method 300 analyzes the relationship of the prompt and the extracted instructions to the generated text response to determine a loss score for the performance of the large language mode, and then generates and applies adjustments (e.g., adjustments 148) to the weights of the LLM to improve the loss score.

In one embodiment, the text generation loss function evaluates how correctly a text response generated from the text prompt follows various types of instructions in the text prompt, and strengthens or enhances the measure of loss for responses that are incorrect with regard to the instructions. In one embodiment, text generation tuning method 300 (i) iteratively checks, for one or more text prompts, that the generated response obeys the instructions that were extracted from the prompt; and (ii) make adjustments to the weights for the LLM to increase compliance with the instructions. The penalties for non-compliance with instructions act to increase LLM ability to accurately follow instructions when generating text.

In one embodiment, the extracted instructions were determined to be of particular types of instruction, for example as described above at block 315. The extracted instructions for the various particular types are directed to various component loss functions (of the text generation loss function) that assess compliance with the particular type of instruction. In one embodiment, the component loss function assigned to analyze the generated response for compliance with an individual instruction is chosen based on the labeled or tagged type assigned to the individual instruction. The evaluations for compliance with the various types instructions will be included in the overall output for the text generation loss function. For example, the output of the component loss functions will be incorporated into the text generation loss function, for example by weighted averaging of the component loss values.

The text generation loss function may strengthen the measure of loss where embedding of the text prompt and generated response differ drastically and thus indicate low relevance of the response to the prompt. In one embodiment, text generation tuning method 300 further iteratively checks, for the one or more text prompts, that the generated text response is similar in embedding (i.e., relevant) to the text prompt, and (ii) make adjustments to the weights for the LLM to increase embedding similarity between the generated text response and the text prompt. The penalty for embedding dissimilarity of prompt and response act to increase LLM ability to stay “on topic” or relevant when generating text.

The text generation loss function may also make the measure of loss stronger where the response is excessively repetitive. In one embodiment, text generation tuning method 300 also iteratively, for the one or more text prompts, checks that the generated text response is not repetitive, and (ii) make adjustments to the weights for the LLM to reduce repetitiveness of generated text responses. The penalty for repetitiveness acts to increase LLM ability to be concise and not duplicate portions of its response.

In one embodiment, text generation tuning method initializes an LLM fine-tuner (such as LLM fine tuner 108) to perform the steps of block 320. In one embodiment, text generation tuning method (i) accesses a text prompt and the instructions extracted from the text prompt; (ii) uses the LLM in its current state of training to generate a text response to the prompt; (iii) provides the text prompt, the extracted instructions, and the generated text response as inputs to the text generation loss function; (iv) applies the component loss analyses of format loss, length loss, narrative loss, repetitive loss, and embedding similarity loss to calculate an overall text generation loss; and (v) adjusts weights (or other parameters) of the LLM by backpropagation or other optimization techniques to reduce the calculated text generation loss. In one embodiment, the fine-tuning process is repeated for a plurality of distinct text prompts and extracted instructions, for example through an epoch of fine tuning.

The application of the component loss analyses includes (i) generating format loss by determining an extent or degree to which the generated text response complies with extracted instructions that are labeled as directed to format; (ii) generating length loss by determining an extent or degree to which the generated text response complies with extracted instructions—such as word count, sentence, or paragraph length constraints—that are labeled as directed to length; and (iii) generating narrative loss by determining an extent or degree to which the generated text response adheres to the narrative perspective specified by instructions labeled as directed to narrative perspective.

Where multiple extracted instructions are designated for one particular type of instruction loss, the loss analysis for the type of instruction loss will be performed multiple times, once for each instruction of that type, and the results combined in the overall text generation loss. For example, where a text prompt has a plurality of extracted instructions regarding format, the format loss analysis will be performed for each instruction, and the individual results combined in an average to form the format loss. Where no extracted instruction is available for format loss, length loss, narrative loss, (or other instruction loss analyses), the associated loss analysis need not be performed, and may be given no weight in the overall text generation loss. The format loss, length loss, and narrative loss analyses thus each penalize non-compliance of the generated text response with the extracted instructions.

In one embodiment, the steps of block 320 are performed by LLM fine-tuner 108 and its components such as text generation loss function 134 and large language model 130. At the conclusion of block 315, text generation tuning method has taken a text prompt and extracted instructions, and used them to improve the performance of a large language model at the task of text generation.

At block 325, text generation tuning method 300 generates an evaluation score (e.g., evaluation score 150) for performance of the tuned large language model (e.g., tuned large language model 132) as a text generator based on a value of the text generation loss function (e.g., text generation loss function 134) for a second generated text response (e.g., second generated response 152). In one embodiment, an automatic LLM evaluator (e.g., automatic LLM evaluator 110) executes the tuned LLM on a reference text prompt (e.g., reference text prompt 124) to generate a second text response for testing the tuned LLM. Then, the automatic LLM evaluator executes the text generation loss function to evaluate the second test response for compliance with instructions from the reference text prompt, repetitiveness, and embedding similarity to the reference text prompt. In one embodiment, the evaluation score is a single, composite score for text generation loss by the tuned large language model.

In one embodiment, text generation tuning method 300 initializes an automatic LLM evaluator (such as automatic LLM evaluator 110) to perform the steps of block 325. In one embodiment, text generation tuning method 300 accesses the reference text prompt. Text generation tuning method 300 then uses the tuned LLM to generate a testing text response from the reference text prompt. This test (second) response is a specimen for demonstrating the performance of the tuned LLM following the fine-tuning adjustments to the weights. Text generation tuning method 300 also accesses reference instructions (e.g., extracted reference instructions 128) extracted from the reference text prompt.

Text generation tuning method 300 then inputs the test response and reference instructions into the text generation loss function, and then executes the loss function to assess performance of the tuned LLM based on various aspects of the test response. As discussed in detail above regarding the text generation loss function, the performance of the tuned LLM is evaluated based on compliance with format instructions, compliance with length instructions, compliance with narrative perspective instructions, and in some cases, compliance with other instructions. And, as above, the performance of the tuned LLM is also evaluated based on content repetitiveness and embedding similarity between the reference text prompt and the test response. Text generation tuning method 300 then generates a composite, overall loss score, for example by weighted averaging of the component loss scores.

In one embodiment, the text generation tuning method 300 may further compare the second generated text response with a model text response (e.g., reference model response 126) provided for the reference text prompt, although this may be unnecessary. The comparison between the model text response and the second generated text response determines how closely the second generated response (produced by the tuned LLM) resembles an exemplar of generated text. To compare the generated and reference responses, the text generation loss function may evaluate embedding similarity of the second generated text response and the model text response. And, the text generation loss function may evaluate recall and/or precision between the second generated text response and the model text response. The results of the comparison of model response and response generated by the tuned LLM may be included in the weighted average loss score produced by the text generation loss function.

Text generation tuning method 300 then assigns the overall text generation loss value for the tuned LLM to be the evaluation score for the performance of the tuned LLM. The evaluation score characterizes LLM's capability to generate text that complies with the given instructions and satisfies the quality criteria established. Text generation tuning method 300 then provides the evaluation score to a deployment decider (e.g., deployment decider 112) for determining whether the tuned LLM is and ready for deployment in a production environment, or needs further rounds of fine-tuning before deployment. For example, text generation tuning method 300 may transmit the evaluation score to the deployment decider.

In one embodiment, the steps of block 325 are performed by automatic LLM evaluator 110 and its components such as text generation loss function 134 and tuned large language model 132. At the conclusion of block 325, text generation tuning method 300 has produced a score representing how much the fine-tuning adjustment to change the LLM to the tuned LLM has improved performance at text generation. Processing continues at block 330.

At block 330, text generation tuning method 300 automatically determines to deploy (e.g., deploy 158) the tuned large language model to a production environment for text generation (e.g., production environment 156) in response to the evaluation score satisfying a threshold (e.g., threshold 154). Or, in one embodiment, text generation tuning method 300 automatically determines whether fine tuning of the tuned large language model is complete in response to the evaluation score satisfying a threshold. In one embodiment, where the threshold is not satisfied, text generation tuning method 300 signals that text generation tuning method 300 is to repeat for the tuned large language model, for example repeating beginning at block 310 above. Where the threshold is satisfied, text generation tuning method signals to initiate or cause automated deployment of the tuned large language model to a production environment for performance of text generation tasks. For example, text generation tuning method 300 automatically determines to deploy the tuned large language model to a text generation task. The deployment is determined in response to the evaluation score satisfying a threshold.

In one embodiment, the text generation tuning method 300 initializes a deployment decider (such as deployment decider 112) to automatically determine whether to deploy the tuned LLM based on satisfying a threshold for text generation performance, or to repeat the fine-tuning process for further training epochs based on failure to satisfy the threshold. The deployment decider defines a threshold (such as threshold 154) for the evaluation score based on pre-determined performance criteria for the LLM, such as improvement over a previous “best” evaluation score for text generation achieved by the LLM under a prior iteration of tuning. The deployment decider then populates the threshold conditions by inputting the value of the evaluation score. The deployment decider evaluates the populated threshold to determine whether the threshold evaluates to a value (such as a Boolean “TRUE”) that indicates the threshold to be satisfied by the evaluation score, or to a value (such as a Boolean “FALSE”) that indicates the threshold to remain unsatisfied by the evaluation score.

If the evaluation shows improvement over the previous best score for text generation performance by at least the threshold amount, the deployment decider automatically deploys the tuned LLM into the production environment to perform text generation tasks. If the evaluation shows insufficient improvement in text generation performance, or even decrease in performance, the tuned LLM is not deployed. Instead, the deployment decider initiates further epochs of training with additional text samples for the tuned LLM, restarting text generation tuning method 300 at block 310 for the tuned LLM. In this way, improvements captured in the tuned LLM that were not sufficient to justify deployment are retained and further refined with additional training, and not discarded.

In one embodiment, once the deployment decider has determined to deploy the tuned LLM, deployment decider automatically carries out the promotion of the LLM to the production environment. In one embodiment, the determination to deploy the tuned LLM may be presented in a user interface, such as a graphical user interface, for user or administrator confirmation or rejection of the deployment.

In one embodiment, a condition of satisfying the threshold is surpassing a previous best (for example, exceeding a previous maximum) for the evaluation score. In one embodiment, the threshold is defined by retrieving a pre-specified threshold for text generation performance from storage. In one embodiment, the threshold is defined by dynamically adjusting threshold conditions based on the previous “best” evaluation score-a prior peak ability of the LLM to generate text. The previous “best” score may be, for example, a maximum score where higher scores indicate better text generation performance, or a minimum score where lower scores indicate better text generation performance. The automatic LLM evaluator may be configured to also store the previous best evaluation score that was previously achieved by the LLM. In one embodiment, the value of the previous best evaluation score, for example the values of recall and precision may be set as minimum conditions to be exceeded in the threshold evaluation. In one embodiment, the value of the previous best evaluation score, plus a pre-determined margin of improvement, are set as minimum conditions to be exceeded in the threshold evaluation. Thus, in one embodiment, text generation tuning method 300 compares the evaluation score to the previous best for the evaluation score.

At the conclusion of block 325, text generation tuning method 300 proceeds to END block 330, where text generation tuning method 300 terminates. At the conclusion of text generation tuning method 300, an LLM has been automatically fine-tuned for improved performance at generating text, and automatically deployed to implement the improved text generation capabilities for text generation tasks going forward.

In one embodiment, a text generation tuning method includes accessing a collection of text samples, wherein the text samples include a natural language text prompt that combines content and instructions and a model response in natural language to the text prompt. The text generation method includes parsing the text samples to extract the instructions from the text prompt. The text generation method includes fine-tuning a large language model to generate text in natural language based on a text generation loss function that (i) penalizes non-compliance with one or more of the extracted instructions by a generated text response to the text prompt and (ii) evaluates similarity of the generated text response to the model response. The text generation method includes generating an evaluation score for performance of the tuned large language model as a text generator based on a value of the text generation loss function for a second generated text response to a second text prompt. And, the text generation method includes automatically determining to deploy the tuned large language model to a text generation task in response to the evaluation score satisfying a threshold established based on a prior training iteration of the large language model.

In one embodiment, a text generation tuning method accesses a collection of text samples, wherein the text samples include human language text content and human language text instructions. The text generation tuning method parses the text samples to extract the instructions. The text generation tuning method trains a large language model to generate content that approximates the human language text content based on a loss function that penalizes non-compliance with one or more of the instructions. The text generation tuning method generates an evaluation score for performance of the trained LLM as a text generator based on scoring by the LLM of compliance with the instructions. The text generation tuning method transmits an electronic message that text generation ability of the LLM is improved in response to the evaluation score exceeding a maximum evaluation score of an earlier training iteration of the LLM.

### Example Features of Text generation Tuning Method

In one embodiment, fine-tuning the large language model (as discussed for block 320) further includes generating a value of format loss. The value of format loss indicates an extent to which the generated text response complies with one or more of the extracted instructions that specify a format of the generated text response.

In one embodiment, fine-tuning the large language model (as discussed for block 320) further includes generating a value of length loss. The value of length loss indicates an extent to which the generated text response complies with one or more of the extracted instructions that specify a length of the generated text response.

In one embodiment, fine-tuning the large language model (as discussed for block 320) further includes generating a value of narrative loss. The value of narrative loss indicates an extent to which the generated text response complies with one or more of the extracted instructions that specify a narrative perspective of the generated text response.

In one embodiment, fine-tuning the large language model (as discussed for block 320) further includes generating a value of repetitive loss. The value of repetitive loss indicates an extent to which one or more portions of the generated text response substantially repeat.

In one embodiment, fine-tuning the large language model (as discussed for block 320) further includes generating a value of embedding similarity loss. The value of embedding similarity loss indicates an extent to which the generated text response diverges semantically from the text prompt.

In one embodiment, text generation tuning method 300 performs steps for using an additional LLM to evaluate loss on one or more of the loss metrics. Therefore, in one embodiment, when fine-tuning the large language model (as discussed for block 320), text generation tuning method 300 automatically generates a prompt to an additional large language model that requests generation of one or more of a loss value for format loss, a loss value for length loss, a loss value for narrative loss, or a loss value for repetitive loss. Then, text generation tuning method 300 automatically submits the prompt to the additional large language model to cause the additional large language model to generate the one or more loss values. And, text generation tuning method 300 bases the text generation loss function on the loss values generated by the additional large language model.

In one embodiment, when fine-tuning the large language model, text generation tuning method 300 generates the value for the text generation loss function by combining format loss, length loss, and narrative loss. The text generation loss function includes a value of format loss that indicates an extent to which the generated text response complies with one or more of the extracted instructions that specify a format of the generated text response. The text generation loss function includes a value of length loss that indicates an extent to which the generated text response complies with one or more of the extracted instructions that specify a length of the generated text response. And, the text generation loss function includes a value of narrative loss that indicates an extent to which the generated text response complies with one or more of the extracted instructions that specify a narrative perspective of the generated text response.

In one embodiment, when fine-tuning the large language model, text generation tuning method 300 generates embedding similarity loss as a component of the text generation loss function. To generate the text generation tuning method, text generation tuning method 300 embeds the text prompt into a first vector and embeds the generated response into a second vector. Text generation tuning method 300 determines a cosine distance between the first vector and the second vector as the embedding similarity loss. The text generation loss function is based in part on the embedding similarity loss.

In one embodiment, fine-tuning of the large language model by the text generation tuning method 300 includes steps for generating the value of the text generation loss function based on generating a value of loss that indicates an extent to which the generated text response is substantially repetitive. For example text generation tuning method 300 generates a repetitive loss by initially separating the generated response into individual tokens. Then, text generation tuning method performs one or more of a token frequency analysis, an n-gram analysis, a lexical diversity analysis, a cosine distance analysis, a recall analysis, a precision analysis, or a pattern matching analysis of the tokens to quantify the extent to which the generated text response is repetitive. And, text generation loss tuning method 300 combines results from the one or more analyses in a weighted average as the repetitive loss. The text generation loss function is based in part on the repetitive loss, in addition to an instruction loss that penalizes non-compliance with one or more extracted instructions.

In one embodiment, the text generation tuning method 300 further generates the value for the text generation loss function based at least in part on a value of loss that indicates an extent to which the generated text response complies with one or more of the extracted instructions that specifies one of tone, writing style, vocabulary, audience, inclusion of information, or exclusion of information.

In one embodiment, the text generation tuning method 300 further includes analyzing the generated text response for compliance with extracted instructions using an additional large language model, wherein the text generation loss function is based at least in part on the analysis by the additional large language model.

In one embodiment, text generation tuning method 300 performs steps to route particular types of extracted instructions to component loss functions of the text generation loss function that are configured to assess compliance by the generated text response with the particular type of instruction. For example, text generation tuning method 300 determines an extracted instruction to be of a particular type of instruction. Text generation tuning method 300 then evaluates the extracted instruction with a component loss function of the text generation loss function that assesses compliance by the generated text response with the particular type of instruction. And, text generation tuning method 300 then incorporates output of the component loss function into the text generation loss function.

In one embodiment, text generation tuning method 300 fine tunes the large language model based on a combination of instruction loss, repetitive loss, and embedding similarity loss, as discussed above at block 325. Text generation tuning method 300 generates a value of instruction loss (such as format loss, length loss, or narrative perspective loss) that indicates an extent to which the generated text response complies with one or more of the extracted instructions. Text generation tuning method 300 generates a value of repetitive loss that indicates an extent to which one or more portions of the generated text response substantially repeat. Text generation tuning method 300 generates a value of embedding similarity loss that indicates an extent to which the generated text response diverges semantically from the text prompt. And, text generation tuning method 300 combining the values of instruction loss, repetitive loss, and embedding similarity loss in the text generation loss function.

In one embodiment, fine tunes the large language model by text generation tuning method 300 includes generating an embedding similarity loss between a first embedding of the natural language text prompt and a second embedding of the generated text response in a vector space, wherein the embedding similarity loss is based on difference of alignment between the first embedding of the natural language text prompt and the second embedding of the generated text response.

In one embodiment, where a condition of satisfying the threshold includes surpassing a previous best for the evaluation score, text generation tuning method 300 further includes comparing the evaluation score to the previous best for the evaluation score to determine whether the threshold has been satisfied.

### Cloud or Enterprise Embodiments

In one embodiment, the present system (such as text generation tuning system 100) is a computing/data processing system including a computing application or collection of distributed computing applications for access and use by other client computing devices that communicate with the present system over a network. In one embodiment, text generation tuning system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, text generation tuning system 100 is a centralized server-side application that provides at least the functions disclosed herein and that is accessed by many users by way of computing devices/terminals communicating with the computers of text generation tuning system 100 (functioning as one or more servers) over a computer network. In one embodiment text generation tuning system 100 may be implemented by a server or other computing device configured with hardware and software to implement the functions and features described herein.

In one embodiment, the components of text generation tuning system 100 may be implemented as sets of one or more software modules executed by one or more computing devices specially configured for such execution. In one embodiment, the components of text generation tuning system 100 are implemented on one or more hardware computing devices or hosts interconnected by a data network. For example, the components of text generation tuning system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes. In one embodiment, as a practical matter, text generation tuning system 100 may employ GPU hardware resources for fine-tuning an LLM for text generation in order to complete retraining of the weights of the LLM within a reasonable period of time.

In one embodiment, the components of text generation tuning system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of text generation tuning system 100 may (i) generate or compose an electronic message or signal to issue a command or request to another component, (ii) transmit the message or signal to other components of text generation tuning system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by text generation tuning system 100, for example through a web interface server. In one embodiment, the remote computing system may send requests to and receive responses from text generation tuning system 100. In one example, access to the information or applications may be effected through use of a web browser on a personal computer or mobile device. In one example, communications exchanged with text generation tuning system 100 may take the form of remote representational state transfer (REST) requests using JavaScript object notation (JSON) as the data interchange format for example, or simple object access protocol (SOAP) requests to and from XML servers. The REST or SOAP requests may include API calls to components of LLM tuning system 100.

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### Computing Device Embodiment

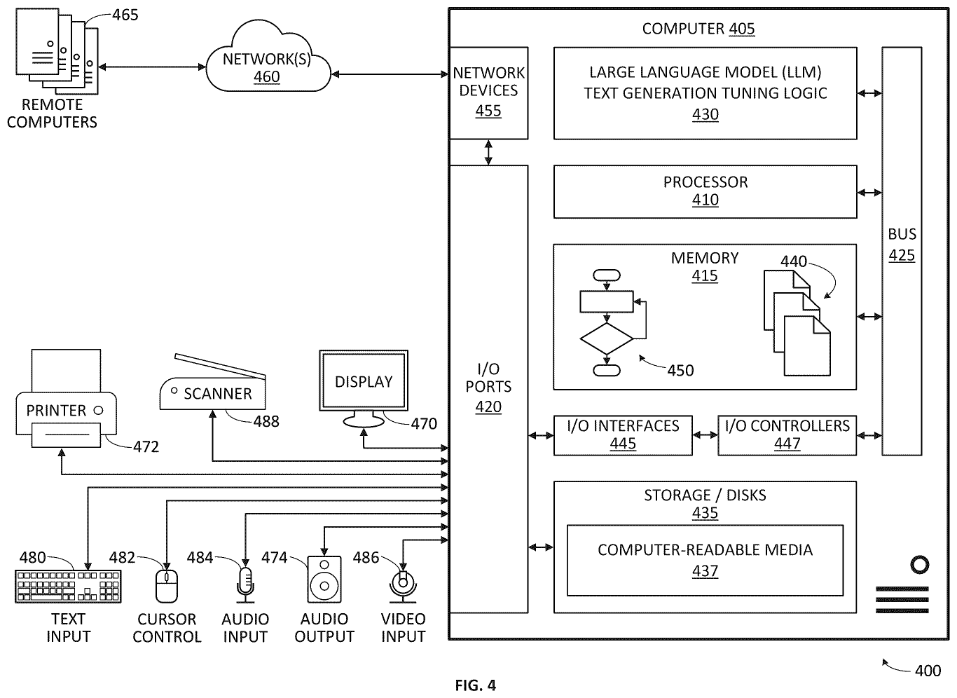

FIG. 4 illustrates an example computing system 400 that is configured and/or programmed as a special purpose computing device(s) with one or more of the example systems and methods described herein, and/or equivalents. The example computing device may be a computer 405 that includes at least one hardware processor 410, a memory 415, and input/output ports 420 operably connected by a bus 425. In one example, the computer 405 may include LLM text generation tuning logic 430 configured to facilitate automated fine-tuning of an LLM to improve text generation functionality of the LLM, similar to logic, systems and methods shown in and described with reference to FIGS. 1-3.

In different examples, the logic 430 may be implemented in hardware, one or more non-transitory computer-readable media 437 with stored instructions, firmware, and/or combinations thereof. While the logic 430 is illustrated as a hardware component attached to the bus 425, it is to be appreciated that in other embodiments, the logic 430 could be implemented in the processor 410, stored in memory 415, or stored in disk 435.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate automated fine-tuning for large language models. The means may also be implemented as stored computer executable instructions that are presented to computer 405 as data 440 that are temporarily stored in memory 415 and then executed by processor 410.

Logic 430 may also provide means (e.g., hardware, non-transitory computer-readable medium that stores executable instructions, firmware) for performing one or more of the disclosed functions and/or combinations of the functions.

Generally describing an example configuration of the computer 405, the processor 410 may be a variety of various processors including dual microprocessor and other multi-processor architectures. A memory 415 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 435 may be operably connected to the computer 405 via, for example, an input/output (I/O) interface (e.g., card, device) 445 and an input/output port 420 that are controlled by at least an input/output (I/O) controller 447. The disk 435 may be, for example, a magnetic disk drive, a solid-state drive, a floppy disk drive, a tape drive, a Zip drive, a flash memory card, a memory stick, and so on. Furthermore, the disk 435 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 415 can store a process 450 and/or a data 440, for example. The disk 435 and/or the memory 415 can store an operating system that controls and allocates resources of the computer 405.

The computer 405 may interact with, control, and/or be controlled by input/output (I/O) devices via the input/output (I/O) controller 447, the I/O interfaces 445, and the input/output ports 420. Input/output devices may include, for example, one or more network devices 455, displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 435, and so on. The input/output ports 420 may include, for example, serial ports, parallel ports, and USB ports.

The computer 405 can operate in a network environment and thus may be connected to the network devices 455 via the I/O interfaces 445, and/or the I/O ports 420. Through the network devices 455, the computer 405 may interact with a network 460. Through the network 460, the computer 405 may be logically connected to remote computers 465. Networks with which the computer 405 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor cause a computing system to:
access a collection of text samples, wherein the text samples include a natural language text prompt that combines content and instructions;
parse the text samples to extract the instructions from the text prompt;
fine-tune a large language model to generate text in natural language based on a text generation loss function that penalizes non-compliance with one or more of the extracted instructions by a generated text response to the text prompt;
generate an evaluation score for performance of the tuned large language model as a text generator based on a value of the text generation loss function for a second generated text response; and
automatically determine to deploy the tuned large language model to a production environment for text generation in response to the evaluation score satisfying a threshold.

2. The non-transitory computer-readable media of claim 1, wherein the computer-executable instructions further cause the computer system to generate a value of format loss that indicates an extent to which the generated text response complies with one or more of the extracted instructions that specify a format of the generated text response.

3. The non-transitory computer-readable media of claim 1, wherein the computer-executable instructions further cause the computer system to generate a value of length loss that indicates an extent to which the generated text response complies with one or more of the extracted instructions that specify a length of the generated text response.

4. The non-transitory computer-readable media of claim 1, wherein the computer-executable instructions further cause the computer system to generate a value of narrative loss that indicates an extent to which the generated text response complies with one or more of the extracted instructions that specify a narrative perspective of the generated text response.

5. The non-transitory computer-readable media of claim 1, wherein the computer-executable instructions further cause the computer system to generate a value of repetitive loss that indicates an extent to which one or more portions of the generated text response substantially repeat.

6. The non-transitory computer-readable media of claim 1, wherein the computer-executable instructions further cause the computer system to generate a value of embedding similarity loss that indicates an extent to which the generated text response diverges semantically from the text prompt.

7. The non-transitory computer-readable media of claim 1, wherein the computer-executable instructions further cause the computer system to:
automatically generate a prompt to an additional large language model that requests generation of one or more of a loss value for format loss, a loss value for length loss, a loss value for narrative loss, or a loss value for repetitive loss;
automatically submit the prompt to the additional large language model to cause the additional large language model to generate the one or more loss values; and
base the text generation loss function on the loss values generated by the additional large language model.

8. A computing system, comprising:
at least one processor connected to at least one memory;
one or more non-transitory computer readable media including instructions stored thereon that when executed by at least the processor cause the computing system to:
access a collection of text samples, wherein the text samples include a natural language text prompt that combines content and instructions;
parse the text samples to extract the instructions from the text prompt;
fine-tune a large language model to generate text in natural language based on a text generation loss function that penalizes non-compliance with one or more of the extracted instructions by a generated text response to the text prompt;
generate an evaluation score for performance of the tuned large language model as a text generator based on a value of the text generation loss function for a second generated text response; and
automatically determine to deploy the tuned large language model to a production environment for text generation in response to the evaluation score satisfying a threshold.

9. The computing system of claim 8, wherein the computer-executable instructions for fine-tuning a large language model further include instructions that when executed by the processor cause the computing system to generate the value for the text generation loss function based on combining:
a value of format loss that indicates an extent to which the generated text response complies with one or more of the extracted instructions that specify a format of the generated text response;
a value of length loss that indicates an extent to which the generated text response complies with one or more of the extracted instructions that specify a length of the generated text response; and
a value of narrative loss that indicates an extent to which the generated text response complies with one or more of the extracted instructions that specify a narrative perspective of the generated text response.

10. The computing system of claim 8, wherein the computer-executable instructions for fine-tuning a large language model further include instructions that when executed by the processor cause the computing system to generate embedding similarity loss by:
embedding the text prompt into a first vector;
embedding the generated response into a second vector; and
determining a cosine distance between the first vector and the second vector as the embedding similarity loss;
wherein the text generation loss function is based in part on the embedding similarity loss.

11. The computing system of claim 8, wherein the computer-executable instructions for fine-tuning a large language model further include instructions that when executed by the processor cause the computing system to generate a repetitive loss by:
separating the generated response into individual tokens;
performing one or more of a token frequency analysis, an n-gram analysis, a lexical diversity analysis, a cosine distance analysis, a recall analysis, a precision analysis, or a pattern matching analysis of the tokens; and
combining results from the one or more analyses in a weighted average as the repetitive loss;
wherein the text generation loss function is based in part on the repetitive loss.

12. The computing system of claim 8, wherein the computer-executable instructions for fine-tuning a large language model further include instructions that when executed by the processor cause the computing system to generate the value for the text generation loss function based on a value of loss that indicates an extent to which the generated text response complies with one or more of the extracted instructions that specifies one of tone, writing style, vocabulary, audience, inclusion of information, or exclusion of information.

13. The non-transitory computer-readable media of claim 1, wherein the computer-executable instructions further cause the computer system to analyze the generated text response for compliance with extracted instructions using an additional large language model, wherein the text generation loss function is based at least in part on the analysis by the additional large language model.

14. A computer-implemented method, comprising:
accessing a collection of text samples, wherein the text samples include a natural language text prompt that combines content and instructions;
extracting the instructions from the text prompt;
fine-tuning a large language model to generate text in natural language based on a text generation loss function that penalizes non-compliance with one or more of the extracted instructions by a generated text response to the text prompt;
generating an evaluation score for performance of the tuned large language model as a text generator based on a value of the text generation loss function for a second generated text response; and
automatically signaling that the fine tuning of the tuned large language model is complete in response to the evaluation score satisfying a threshold.

15. The computer-implemented method of claim 14, further comprising:
determining an extracted instruction to be of a particular type of instruction;
evaluating the extracted instruction with a component loss function of the text generation loss function that assesses compliance by the generated text response with the particular type of instruction; and
incorporating output of the component loss function into the text generation loss function.

16. The computer-implemented method of claim 14, wherein fine-tuning the large language model further comprises:
generating a value of instruction loss that indicates an extent to which the generated text response complies with one or more of the extracted instructions;
generating a value of repetitive loss that indicates an extent to which one or more portions of the generated text response substantially repeat;
generating a value of embedding similarity loss that indicates an extent to which the generated text response diverges semantically from the text prompt; and
combining the values of instruction loss, repetitive loss, and embedding similarity loss in the text generation loss function.

17. The computer-implemented method of claim 14, wherein fine-tuning the large language model further comprises generating an embedding similarity loss between a first embedding of the natural language text prompt and a second embedding of the generated text response in a vector space, wherein the embedding similarity loss is based on difference of alignment between the first embedding of the natural language text prompt and the second embedding of the generated text response.

18. The computer-implemented method of claim 14, further comprising generating the value for the text generation loss function based at least in part on a value of loss that indicates an extent to which the generated text response complies with one or more of the extracted instructions that specifies one of tone, writing style, vocabulary, audience, inclusion of information, or exclusion of information.

19. The computer-implemented method of claim 14, wherein a condition of satisfying the threshold includes surpassing a previous best for the evaluation score, the method further comprising comparing the evaluation score to the previous best for the evaluation score.

20. The computer-implemented method of claim 14, further comprising analyzing the generated text response for compliance with extracted instructions using an additional large language model, wherein the text generation loss function is based at least in part on the analysis by the additional large language model.
